(19) United States
(12) Patent Application Publication
(10) Pub. No.: US 2006/0031939 A1
(43) Pub. Date: Feb. 9, 2006

(54) Compact disc with new feature

(76) Inventor: Jasim Saleh Al-Azzawi, Arlington, VA (US)

Correspondence Address: Jasim Saleh Al-Azzawi, 1300 Army Navy Drive, Apartment 404, Arlington, VA, 22202, US

(21) Appl. No.: 10/913,437

(22) Filed: Aug. 9, 2004

(51) Int. Cl. H04N 7/16; G06F 17/30; H04L 9/32; G06F 7/04; G06K 9/00; H03M 1/68; H04K 1/00; H04L 9/00

(52) U.S. Cl. 726/26; 726/33

(57) ABSTRACT

In this invention the CD setup data is placed on a remote computer, and when a user purchases a compact disc it can not be setup unless it is connected via the Internet to a remote computer to receive the necessary data, and that cannot be achieved unless a new type of passwords are used which form the core of this invention, it is a password usable for one time only and is called a disposable password, the user types this disposable password on the computer during CD setup for the first time, and each time the CD setup is done the computer receive a new disposable password which is absolutely necessary for the next setup, where any unlawfully copied CD will be useless since the new disposable password is known only to the rightful owner who receives a new disposable password each time a CD setup is carried out.

### BACKGROUND OF THE INVENTION

The field of this invention is the compact disc “CD” used by computers where a CD is used to store program software such as Windows98, Windows2000, Windows XP, Office97, AutoCAD14 or Adobe . . . etc. By means of this invention it will absolutely impossible to copy the CD by an average person using a CD writer to copy from CD to CD using his/her personal computer. Furthermore, it will be also totally impossible for large overseas companies to copy the CD despite the expenditure of huge amount of financial resources on research to copy such a CD. As a result of this invention any company in the future utilizing such an invention will be %100 sure that no one will be capable to copying its CDs.

Companies, like Microsoft, annually spend billions of dollars on research to develop their software and in return expect intellectual property rights agreements to protect their products and interests. However, software piracy has cost such companies billions of dollars in profit loss. Thus, through this invention, CD piracy will become a thing of the past.

### BRIEF SUMMARY OF THE INVENTION

The primary principle upon which this invention is based is the disposable password. This new type of passwords will be used only once and then becomes redundant. This invention outlines the mechanism through which only the rightful owner of the CD knows these passwords.

In this invention we put the data by which the CD can be setup on a remote computer. So when someone purchases a CD he/she can not set it up on their PC unless he/she connect, via the Internet, to a remote computer to receive the data necessary to setup the CD. The setup process will not be possible to complete unless and until the disposable password mentioned above is used.

So the idea of the invention in brief is:

A—Making a CD which:

1—It needs a password to open the setup folder called the Permanent Password ‘PPW’ where this PPW comes with the CD printed on the CD's cover.

2—It needs a password to setup the CD called Complex Password ‘CPW’ where the CPW is kept on a remote computer inside a folder called the Remote Passwords Folder ‘RPF’.

B—For each sold CD we place on a remote computer a folder containing tens of disposable passwords. This folder, called the Remote Passwords Folder ‘RPF’, opens only when it receives the Permanent Password assigned to it where this particular Permanent Password belongs to a CD assigned to this particular Remote Passwords Folder. Only when the Remote Password Folder receive the Disposable Password it will start to send the Complex Password plus the next Disposable Password which is absolutely necessary for setting up the CD next time. Each Remote Passwords Folder contains a number of Disposable Passwords and it deletes each Disposable Password, after it has been used, i.e. so this particular password can not be used again.

C—The way this invention works is:

1—During the CD setup we connect to the Internet and send the Permanent Password.

2—Remote Passwords Folder assigned to this particular CD opens. And only when we send a new Disposable Password the Remote Passwords Folder send us the Complex Password to permit the CD setup.

3—The Remote Passwords Folder sends a new Disposable Password to be saved inside the copybook for Disposable Passwords where we will use this new Disposable Password in the next setup and without it setup will not be possible next time.

As explained above, this invention outlines the mechanism by which only the rightful owner of the CD knows these vital Disposable passwords.

### BRIEF DESCRIPTION OF THE SEVERAL VIEWS OF THE

### DRAWINGS

There are no drawings.

### DETAILED DESCRIPTION OF THE INVENTION

The core of this invention is the mechanism through which only the rightful owner of the CD knows the Disposable Passwords. A Disposable Password is a password that can be used only once then it becomes redundant and unusable again. When an individual purchases a CD he/she receive one Disposable Password that will be used to setup the CD on his/her PC and without it is impossible to setup the CD. Upon completion of CD setup the owner will receive a new Disposable Password where he/she saves this important new Disposable Password in the copybook for Disposable Passwords. The new Disposable Password is vital for setting up the CD next time and without it setup will be absolutely impossible because the Remote Passwords Folder, located on a remote computer, will not send the necessary data to setup the computer with, unless it receives a new Disposable Password. All steps explained above are done through the Internet.

The following steps will explain the invention in a systematic way:—

1—We make a CD that requires a password to open its setup folder. It is called the Permanent Password and it comes printed on the CD's cover when purchased.

2—When the setup folder opens it needs a password to start setting up the CD on the computer. It is called the Complex Password and is located in a Remote Passwords Folder on a remote computer.

3—The setup folder has a file capable of communicating with the Remote Passwords Folder.

4—The software folders on the CD are incomplete where each folder requires a small part to complete it and enable to become functional. These parts are called Key Parts of the CD's Folders.

5—We assign a site on the Internet or we can connect a computer to the Internet which contains millions of folders where each sold CD has its own particular folder only assigned to it. This folder's name is Remote Passwords Folder.

6—The Remote Passwords Folder contains the Disposable Passwords, the Complex Password, a program capable of communicating with the setup folder on the CD, as well as containing the key parts of CD's folders.

The steps by which a person sets up the CD on his computer are:—

1—We insert the CD into the CD drive.

2—We double click on the icon of the CD drive to open the CD.

3—Only one folder shows it is called the setup folder.

4—We double click the setup folder and it opens.

5—A dialog box appears asking to type the Permanent Password.

6—We type the Permanent Password, which comes printed on the CD's cover.

7—The setup folder opens and starts to communicate with the computer taking the computer serial number.

8—A dialog box appears asking to connect the computer to the Internet.

9—We connect the computer to the Internet.

10—A dialog box appears and it shows the Internet address and asks us to click the OK to start the connection with the remote computer.

11—When we click the OK the setup folder starts communicating with the remote computer. This communication includes the following steps:

a—The setup folder sends the Permanent Password and the Accompanying Password so that the Remote Passwords Folder, assigned to this particular CD, opens up and starts communicating.

b—The Remote Passwords Folder assigned to this particular CD acquires the computer serial number from the setup folder. The reason that the Remote Passwords Folder takes the computer serial number is to limit the number of computers allowed to use the same CD, whether it is one computer or more.

c—The Remote Passwords Folder asks for the Disposable Password prompting the appearance of a dialog box and asks us to type the Disposable Password so we type the Disposable Password. The Disposable Password comes printed in a small book called a copybook for Disposable Passwords when the CD is initially purchased.

d—When the Remote Passwords Folder receives the Disposable Password it starts to send the necessary data encrypted along with the computer serial number and with Permanent Password.

e—The setup folder reverse the encryption of the data received from the remote computer where this data contains the following:

1—The Complex Password by which the setting up of the CD will start.

2—The key parts of the folders of the CD.

3—The new Disposable Password.

After step (11) we can disconnect Internet connection because the computer has received all the required data.

12—The setup folder starts setting up the CD on the computer and when it finishes a new Disposable Password appears on the screen. We write it down in the copybook for Disposable Passwords for latter use. At this stage the setup is complete and we can remove the CD and save it with the copybook for Disposable Passwords in a safe place.

The time needed to be connected to the Internet is only few seconds because step (11) doesn't last more than 20 seconds. And as we do not need the Internet before and after step (11) we can disconnect from the Internet after step (11).

The difference between the old and new manner of setting up the CD is a mere one minute connection to the Internet.

In this new way each CD sold has its own assigned folder in a remote computer. Thus, if ten million CDs are sold the remote computer should contain ten million folders, a folder assigned to each CD. These folders are called Remote Passwords Folder. Each Remote Passwords Folder contains a number of Disposable Passwords and depending on the price paid may range from 10 to 1000 passwords.

Each Disposable Password is used only once and will become redundant and unusable again because the Remote Passwords Folder will not accept a previously used Disposable Password. Consequently it will neither send the Complex Password nor the key parts of the folders when a previously used Disposable Password is used again as each Disposable Password when it is used it is deleted into a recycle bin inside the Remote Passwords Folder

Each time we setup the CD the Remote Passwords Folder gets a Disposable Password from us to permit setting up the CD and send us back a new Disposable Password for latter use. Consequently any unlawfully copied compact disc will be useless as the new Disposable Password is only known to a rightful owner who receives a different Disposable Password each time he sets up the compact disc.

We should decide the number of Disposable Passwords each Remote Passwords Folder should contain i.e. whether 10, 100, or 1000 Disposable Passwords.

After using all the allocated Disposable Passwords the CD will be unable to be setup again unless the user buys a new batch of Disposable Passwords to be inserted in his Remote Passwords Folder. This can be done by sending the Permanent Password which determines the Remote Passwords Folder assigned to this particular CD. And we must also send the first Disposable Password, which guarantees that the user is the rightful owner of the CD, as well as the fee necessary to purchase a specific number of required Disposable Passwords through the Internet. Upon receiving all the sent data the remote computer will insert new Disposable Passwords into the Remote Passwords Folder assigned to the Permanent Password of the owner's CD.

When a Disposable Password is used and the setup is done the Remote Passwords Folder deletes this particular Disposable Password, rendering it useless and unusable again. The process is repeated each time we setup the CD until the Remote Passwords Folder deletes all its Disposable Passwords and it becomes depleted of all the Disposable Passwords. Then the CD can no longer be setup again unless new batch of Disposable Passwords are purchased.

The first Disposable Password can be sent to the CD buyer either by an e-mail instead of placing it inside the copybook for Disposable Password guaranteeing that only the CD buyer will know the first Disposable Password. Thus, if someone other than the purchaser opens the CD box they will not find the Disposable Password. Or the first Disposable Password is created and given by the buyer to the CD vendor so that the CD manufacturer will assign the purchaser's desired Disposable Password to the Remote Passwords Folder assigned to that particular CD which is determined by the Permanent Password of the CD. And as only the purchaser has the lawful CD any unlawfully created copy will be useless as no one other than the purchaser has the Disposable Password. This method will compel everyone to buy his/her CD from a licensed vendor.

The third method is the best and preferred way. Through it the first Disposable Password is printed on a plastic card and hidden under a non-transparent film. When the protective film is scratched off the Disposable Password is revealed i.e. the CD will come with a plastic card containing one, two, three or more Disposable Passwords, all invisible and protected by a non-transparent film. The other Disposable Passwords are for emergency use when a malfunction occurs on the Internet and the new Disposable Password is not received. In such circumstances the CD owner can use the back up Disposable Passwords by scratching off the next Disposable Password on the plastic card to setup his/her CD.

CDs containing Windows program, such as Windows98, Windows2000 or WindowsXP . . . etc., their setup folders should be capable of setting up all the necessary programs on the computer which are absolutely necessary to have a functioning computer capable of connecting itself to the Internet (this is vitally important when the computer is to be newly formatted). The user will be capable of doing all the steps explained above, enabling the computer to connect to the Internet and receive the Complex Password and the Key Parts of the CD's Folders. Then the CD will be completely and permanently setup on the hard disc. The user should do this within few hours of setting up his/her CD copy, otherwise a file within Windows' software will delete automatically all windows programs from the computer if it does not receive the complex Password in time.

Definitions

Permanent Password: Is a password printed on the CDs cover which:

1—The setup folder is opened using this password.

2—It is one of the passwords by which the Remote Passwords Folder is opened.

Accompanying Password: Is a password hidden on the CD and it accompanies automatically the Permanent Password when it is sent to the Remote Passwords Folder. This Accompanying Password is necessary so the Permanent Password of a different CD cannot be used with another CD to open a different Remote Passwords Folder.

Disposable Password: Is the core of this invention and is a new type of passwords where it is used only once and then becomes redundant and unusable.

Complex Password: Is a very long and complex password by which the setup folder manages to setup The CD on the computer. It is located on a remote computer in a Remote Passwords Folder.

Remote Passwords Folder: Is a folder on a remote computer that can be reached by the Internet. This folder needs a Permanent Password plus an Accompanying Password to be opened. When it opens it needs a Disposable Password to send the Complex Password plus the Key Parts of the CD's Folders.

Key Parts of the CD's Folders: They are parts of the CD folders and they are missing from CD folders but they exist on the Remote Passwords Folder and they are sent to each folder of the CD when the setup starts, certainly after the correct passwords are sent to the Remote Passwords Folder.

The Key Parts of the Folders are not passwords used to open folders with but they are very small portions of the folders and without them the folders can not function.

We may leave all the files intact on the CD without removing some of their parts and place those parts on the remote computer. The only tool by which the Remote Passwords Folder controls the setup is the Complex Password.

Copybook for Disposable Passwords: It is a small copybook that comes with the CD when first purchased. It contains one or multiple Disposable Passwords. These Disposable Passwords are hidden under a non-transparent protective film and can only become visible and legible when the protective film is scratched off to reveal the Disposable Password. Through this protective devise only the rightful CD owner will have access to this vital password. The user will type this Disposable Password on the computer when he/she will setup the CD for the first time.

Each time the CD is setup the Remote Passwords Folder will request from the user an unused Disposable Password and sends him/her a new Disposable Password to be used the next time the CD is setup on the computer. The new Disposable Password is absolutely necessary for setting up the CD the next time and without it setup will fail.

The copybook for Disposable Passwords is useful for writing the new Disposable Password which will be needed for setting up the CD next time as well as preventing the lose of this important password. The copybook and CD should be kept in a safe place.

1- I claim a compact disc that it can not be setup on a computer unless the computer is connected to the Internet or to a remote computer and receive from it important data necessary to setup the compact disc on the computer, and that can not be done unless a new type of passwords are used which forms the core of this invention where this password is unusable for one time only and without it the remote computer will not send the necessary data mentioned above by which the compact disc will be able to setup itself on the computer, each time we setup the compact disc on the computer we receive from the remote computer a new disposable password which is absolutely necessary for the next setup, this mechanism will make the rightful owner of the CD the only user who knows this disposable password.

2- I claim a CD which uses disposable passwords where the rightful owner of the CD receives one or more disposable passwords hidden under a protective non-transparent film so when a user scratches off this protective non-transparent film the disposable password will be revealed and when the user sends the disposable password to the appropriate address on the Internet during setup the computer will receive the necessary data to complete the CD setup on the computer in addition to receiving a new disposable password which is absolutely necessary to setup the CD next time, and this mechanism stops CD piracy.

3- I claim a CD where the data on it is incomplete and is missing some of its data and where these missing parts are kept on a remote computer and during CD setup these missing parts will be sent to the user's computer to complete the data via the Internet.

4- I claim the invention as claimed in claim 2, plus that the first disposable password is not necessarily hidden under a protective non-transparent film, the disposable password could be visible or that the person can receive the first disposable password in any other way.

5- I claim the invention as claimed in claim 2, plus that the data on the CD is incomplete, it is missing some of its data, where the parts which complete the CD's data are kept on a remote computer, where during setup these missing parts will be sent to the user's computer to complete the data via the Internet as well the complex password will be sent from the remote computer to permit the setup.
